(19) United States
(12) Patent Application Publication
(10) Pub. No.: US 2024/0399328 A1
(43) Pub. Date: Dec. 5, 2024

(54) SYSTEMS AND METHODS FOR PRODUCING OLEFINS

(71) Applicant: Dow Global Technologies LLC, Midland, MI (US)

(72) Inventors: Matthew T. Pretz, Lake Jackson, TX (US); Fermin Alejandro Sandoval, Pearland, TX (US); Mohan V. Punganur, Richwood, TX (US); Adam M. McNeeley, Blacksburg, VA (US); Jacobus Kloos, Heerenhoek (NL); Anil V. Sakhare, Friendswood, TX (US)

(73) Assignee: Dow Global Technologies LLC, Midland, MI (US)

(21) Appl. No.: 18/697,853

(22) PCT Filed: Oct. 4, 2022
(86) PCT No.: PCT/US2022/077538

§ 371 Date: Apr. 2, 2024

Related U.S. Application Data
(60) Provisional application No. 63/252,212, filed on Oct. 5, 2021.

(51) Int. Cl. B01J 8/38; B01J 8/26

(52) U.S. Cl. CPC B01J 8/388; B01J 8/26; B01J 2208/00194; B01J 2208/00221

(57) ABSTRACT

Methods for producing olefins may include contacting a hydrocarbon feed stream with a particulate solid, the contacting of the hydrocarbon feed stream with the particulate solid reacting the hydrocarbon feed stream to form a product stream. The method may include separating the particulate solid from the product stream and passing at least a portion of the product stream and the hydrocarbon feed stream through a feed stream preheater. The feed stream preheater may include a shell and tube heat exchanger comprising a shell, a plurality of tubes extending axially through the shell, a shell side inlet, a shell side outlet, a tube side inlet, a tube side outlet, an inlet tube sheet, and an outlet tube sheet. The outlet tube sheet may be connected to the shell by an expansion joint.

### CROSS-REFERENCE TO RELATED APPLICATION

This application claims the benefit of and priority to U.S. Application Ser. No. 63/252,212 filed Oct. 5, 2021, and entitled “SYSTEMS AND METHODS FOR PRODUCING OLEFINS,” the entire contents of which are incorporated by reference in the present disclosure

### TECHNICAL FIELD

Embodiments described herein generally relate to chemical processing and, more specifically, to systems and methods for transferring heat.

### BACKGROUND

Light olefins may be utilized as base materials to produce many types of goods and materials. For example, ethylene may be utilized to manufacture polyethylene, ethylene chloride, or ethylene oxides. Such products may be utilized in product packaging, construction, textiles, etc. Thus, there is an industry demand for light olefins, such as ethylene, propylene, and butene. Light olefins may be produced by different reaction processes depending on the given chemical feed stream, which may be a product stream from a crude oil refining operation. Many light olefins may be produced through processes employing particulate solids, such as solid particulate catalysts.

### SUMMARY

Some reactor systems for processing hydrocarbon feeds to produce olefins include a heat exchanger used to heat a hydrocarbon feedstock before it enters a reactor. The heat exchanger may transfer heat from a product stream back to the hydrocarbon feedstock. However, significant differences in temperature may result in stress between components of the heat exchanger due to uneven thermal expansion of those components. Additionally, the structure of conventional heat exchangers may result in an undesirable pressure drop in the fluids passing through the heat exchanger. As such, there is a need for improved methods and systems for transferring heat from the product stream to the hydrocarbon feedstock.

Presently disclosed are methods and systems for producing olefins that that may address the problems identified with previous designs. In one or more embodiments, the methods and systems for producing olefins may comprise a shell and tube heat exchanger to transfer heat from the product stream to the hydrocarbon feedstock. In embodiments disclosed herein, the shell and tube heat exchangers may comprise one or more of expansion joints, refractory materials, and tubes with enhanced surface area, among other features to increase heat transfer and decrease the thermal stress placed on the heat exchanger and other system components.

According to one or more embodiments disclosed herein, methods for producing olefins may comprise contacting a hydrocarbon feed stream with a particulate solid in a reaction vessel, the contacting of the hydrocarbon feed stream with the particulate solid reacting the hydrocarbon feed stream to form a product stream. The method may comprise separating the particulate solid from the product stream in a gas/solids separation device housed within a particulate solid separation section and passing at least a portion of the product stream and a portion of the hydrocarbon feed stream through a feed stream preheater. The feed stream preheater may comprise a shell and tube heat exchanger comprising a shell, a plurality of tubes extending axially through the shell, a shell side inlet, a shell side outlet, a tube side inlet, a tube side outlet, an inlet tube sheet, and an outlet tube sheet. The outlet tube sheet may be connected to the shell by an expansion joint.

According to one or more embodiments disclosed herein, methods for regenerating particulate solids may comprise regenerating a particulate solid in a particulate solid treatment vessel in the presence of an oxygen containing gas, where the regenerating of the particulate solid may comprise one or more of: oxidizing the particulate solid by contact with an oxygen containing gas; combusting coke present on the particulate solid; or combusting a supplemental fuel to heat the particulate solid. The method may include separating the particulate solid from flue gasses in a gas/solids separation device, and passing at least a portion of the flue gasses and at least a portion of the oxygen containing gasses through a gas preheater. The gas preheater may comprise a shell and tube heat exchanger comprising a shell, a plurality of tubes extending axially through the shell, a shell side inlet, a shell side outlet, a tube side inlet, a tube side outlet, an inlet tube sheet and an outlet tube sheet. The outlet tube sheet may be connected to the shell by an expansion joint.

It is to be understood that both the foregoing brief summary and the following detailed description present embodiments of the technology, and are intended to provide an overview or framework for understanding the nature and character of the technology as it is claimed. The accompanying drawings are included to provide a further understanding of the technology, and are incorporated into and constitute a part of this specification. The drawings illustrate various embodiments and, together with the description, serve to explain the principles and operations of the technology. Additionally, the drawings and descriptions are meant to be merely illustrative, and are not intended to limit the scope of the claims in any manner.

Additional features and advantages of the technology disclosed herein will be set forth in the detailed description that follows, and in part will be readily apparent to those skilled in the art from that description or recognized by practicing the technology as described herein, including the detailed description that follows, the claims, as well as the appended drawings.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 schematically depicts a reactor system comprising a reactor section and a regenerator section, according to one or more embodiments disclosed herein;

FIG. 2 schematically depicts a reaction vessel and exterior riser segment, according to one or more embodiments disclosed herein;

FIG. 3 schematically depicts a particulate solid separation section, according to one or more embodiments disclosed herein; and

FIG. 4 depicts a shell and tube heat exchanger, according to one or more embodiments disclosed herein.

It should be understood that the drawings are schematic in nature, and do not include some components of a fluid catalytic reactor system commonly employed in the art, such as, without limitation, temperature transmitters, pressure transmitters, flow meters, pumps, valves, and the like. It would be known that these components are within the spirit and scope of the present embodiments disclosed. However, operational components, such as those described in the present disclosure, may be added to the embodiments described in this disclosure.

Reference will now be made in greater detail to various embodiments, some embodiments of which are illustrated in the accompanying drawings. Whenever possible, the same reference numerals will be used throughout the drawings to refer to the same or similar parts.

### DETAILED DESCRIPTION

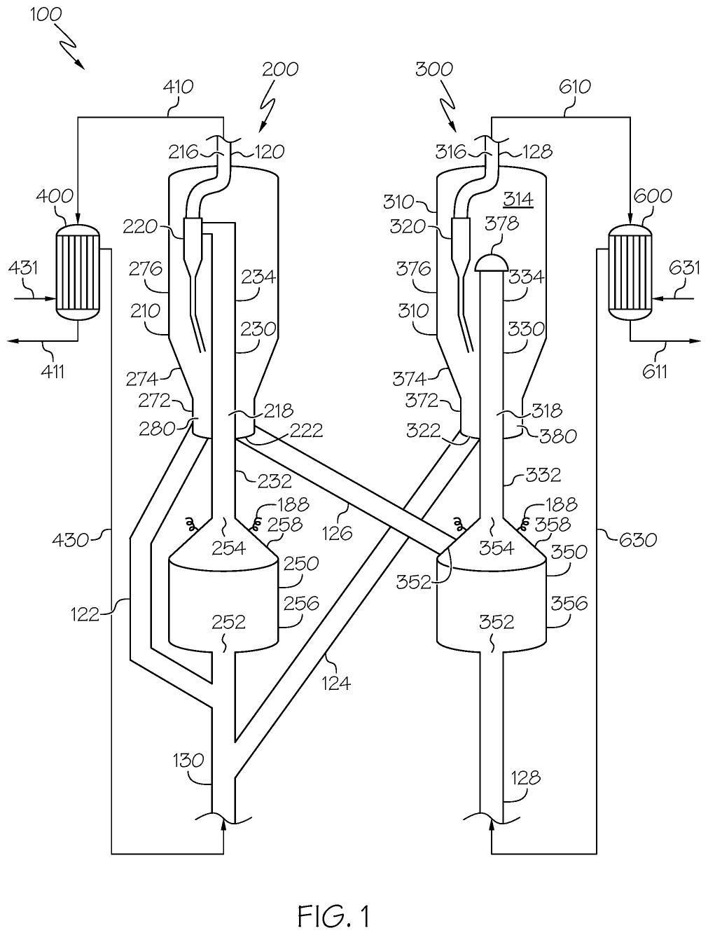

Methods for producing olefins from hydrocarbon feed streams are disclosed herein. Such methods utilize systems that have particular features, such as a particular orientation of system parts. For example, in one or more embodiments described herein, a shell and tube heat exchanger is oriented vertically. One embodiment, which is disclosed in detail herein, is depicted in FIG. 1. However, it should be understood that the principles disclosed and taught herein may be applicable to other systems which utilize different system components oriented in different ways, or different reaction schemes utilizing various catalyst compositions.

Now referring to FIG. 1, the reactor system 100 generally comprises multiple system components, such as a reactor section 200 and a regeneration section 300. As used herein in the context of FIG. 1, a reactor section 200 generally refers to the portion of a reactor system 100 in which the primary process reaction takes place, and the particulate solids are separated from the olefin-containing product stream of the reaction. In one or more embodiments, the particulate solids may be spent, meaning that they are at least partially deactivated. Also, as used herein, a regeneration section 300 generally refers to the portion of a fluid catalytic reactor system where the particulate solids are regenerated, such as through combustion, and the regenerated particulate solids are separated from the other process material, such as evolved gasses from the combusted material previously on the spent particulate solids or from supplemental fuel. The reactor section 200 generally includes a reaction vessel 250, a riser 230 including an exterior riser segment 232 and an interior riser segment 234, and a particulate solid separation section 210. The regeneration section 300 generally includes a particulate solid treatment vessel 350, a riser 330 including an exterior riser segment 332 and an interior riser segment 334, and a particulate solid separation section 310. Generally, the particulate solid separation section 210 may be in fluid communication with the particulate solid treatment vessel 350, for example, by standpipe 126, and the particulate solid separation section 310 may be in fluid communication with the reaction vessel 250, for example, by standpipe 124 and transport riser 130.

Generally, the reactor system 100 may be operated by feeding a hydrocarbon feed and fluidized particulate solids into the reaction vessel 250, and reacting the hydrocarbon feed by contact with fluidized particulate solids to produce an olefin-containing product in the reaction vessel 250 of the reactor section 200. The olefin-containing product and the particulate solids may be passed out of the reaction vessel 250 and through the riser 230 to a gas/solids separation device 220 in the particulate solid separation section 210, where the particulate solids may be separated from the olefin-containing product. The particulate solids may then be transported out of the particulate solid separation section 210 to the particulate solid treatment vessel 350. In the particulate solid treatment vessel 350, the particulate solids may be regenerated by chemical processes. For example, the spent particulate solids may be regenerated by one or more of oxidizing the particulate solid by contact with an oxygen containing gas, combusting coke present on the particulate solids, and combusting a supplemental fuel to heat the particulate solid. The particulate solids may then be passed out of the particulate solid treatment vessel 350 and through the riser 330 to a riser termination device 378, where the gas and particulate solids from the riser 330 are partially separated. The gas and remaining particulate solids from the riser 330 are transported to gas/solids separation device 320 in the particulate solid separation section 310 where the remaining particulate solids are separated from the gasses from the regeneration reaction. The particulate solids, separated from the gasses, may be passed to a solid particulate collection area 380. The separated particulate solids are then passed from the solid particulate collection area 380 to the reaction vessel 250, where they are further utilized. Thus, the particulate solids may cycle between the reactor section 200 and the regeneration section 300.

In one or more embodiments, the reactor system 100 may include either a reactor section 200 or a regeneration section 300, and not both. In further embodiments, the reactor system 100 may include a single regeneration section 300 and multiple reactor sections 200.

Additionally, as described herein, the structural features of the reactor section 200 and regeneration section 300 may be similar or identical in some respects. For example, each of the reactor section 200 and regeneration section 300 include a reaction vessel (i.e., reaction vessel 250 of the reactor section 200 and particulate solid treatment vessel 350 of the regeneration section 300), a riser (i.e., riser 230 of the reactor section 200 and riser 330 of the regeneration section 300), and a particulate solid separation section (i.e., particulate solid separation section 210 of the reactor section 200 and particulate solid separation section 310 of the regeneration section 300). It should be appreciated that since many of the structural features of the reactor section 200 and the regeneration section 300 may be similar or identical in some respects, similar or identical portions of the reactor section 200 and the regeneration section 300 have been provided reference numbers throughout this disclosure with the same final two digits, and disclosures related to one portion of the reactor section 200 may be applicable to the similar or identical portion of the regeneration section 300, and vice versa.

In non-limiting examples, the reactor system 100 described herein may be utilized to produce light olefins from hydrocarbon feed streams. Light olefins may be produced from a variety of hydrocarbon feed streams by utilizing different reaction mechanisms. For example, light olefins may be produced by at least dehydrogenation reactions, cracking reactions, dehydration reactions, and methanol-to-olefin reactions. These reaction types may utilize different feed streams and different particulate solids to produce light olefins. It should be understood that when “catalysts” are referred to herein, they may equally refer to the particulate solid referenced with respect to the system of FIG. 1.

According to one or more embodiments, the reaction may be a dehydrogenation reaction. According to such embodiments, the hydrocarbon feed stream may comprise one or more of ethyl benzene, ethane, propane, n-butane, and i-butane. In one or more embodiments, the hydrocarbon feed stream may comprise at least 50 wt. %, at least 60 wt. %, at least 70 wt. %, at least 80 wt. %, at least 90 wt. %, at least 95 wt. % or even at least 99 wt. % of ethyl benzene. In one or more embodiments, the hydrocarbon feed stream may comprise at least 50 wt. %, at least 60 wt. %, at least 70 wt. %, at least 80 wt. %, at least 90 wt. %, at least 95 wt. % or even at least 99 wt. % of ethane. In additional embodiments, the hydrocarbon feed stream may comprise at least 50 wt. %, at least 60 wt. %, at least 70 wt. %, at least 80 wt. %, at least 90 wt. %, at least 95 wt. % or even at least 99 wt. % of propane. In additional embodiments, the hydrocarbon feed stream may comprise at least 50 wt. %, at least 60 wt. %, at least 70 wt. %, at least 80 wt. %, at least 90 wt. %, at least 95 wt. % or even at least 99 wt. % of n-butane. In additional embodiments, the hydrocarbon feed stream may comprise at least 50 wt. %, at least 60 wt. %, at least 70 wt. %, at least 80 wt. %, at least 90 wt. %, at least 95 wt. % or even at least 99 wt. % of i-butane. In additional embodiments, the hydrocarbon feed stream may comprise at least 50 wt. %, at least 60 wt. %, at least 70 wt. %, at least 80 wt. %, at least 90 wt. %, at least 95 wt. % or even at least 99 wt. % of the sum of ethane, propane, n-butane, and i-butane.

In one or more embodiments, the reaction mechanism may be dehydrogenation followed by combustion (in the same chamber). In such embodiments, a dehydrogenation reaction may produce hydrogen as a byproduct, and an oxygen carrier material may contact the hydrogen and promote combustion of the hydrogen, forming water. Examples of such reaction mechanisms, which are contemplated as possible reactions mechanisms for the systems and methods described herein, are disclosed in WO 2020/046978, the teachings of which are incorporated by reference in their entirety herein.

According to one or more embodiments, the reaction may be a cracking reaction. According to such embodiments, the hydrocarbon feed stream may comprise one or more of naphtha, n-butane, or i-butane. According to one or more embodiments, the hydrocarbon feed stream may comprise at least 50 wt. %, at least 60 wt. %, at least 70 wt. %, at least 80 wt. %, at least 90 wt. %, at least 95 wt. % or even at least 99 wt. % of naphtha. In additional embodiments, the hydrocarbon feed stream may comprise at least 50 wt. %, at least 60 wt. %, at least 70 wt. %, at least 80 wt. %, at least 90 wt. %, at least 95 wt. % or even at least 99 wt. % of n-butane. In additional embodiments, the hydrocarbon feed stream may comprise at least 50 wt. %, at least 60 wt. %, at least 70 wt. %, at least 80 wt. %, at least 90 wt. %, at least 95 wt. % or even at least 99 wt. % of i-butane. In additional embodiments, the hydrocarbon feed stream may comprise at least 50 wt. %, at least 60 wt. %, at least 70 wt. %, at least 80 wt. %, at least 90 wt. %, at least 95 wt. % or even at least 99 wt. % of the sum of naphtha, n-butane, and i-butane.

According to one or more embodiments, the reaction may be a dehydration reaction. According to such embodiments, the hydrocarbon feed stream may comprise one or more of ethanol, propanol, or butanol. According to one or more embodiments, the hydrocarbon feed stream may comprise at least 50 wt. %, at least 60 wt. %, at least 70 wt. %, at least 80 wt. %, at least 90 wt. %, at least 95 wt. % or even at least 99 wt. % of ethanol. In additional embodiments, the hydrocarbon feed stream may comprise at least 50 wt. %, at least 60 wt. %, at least 70 wt. %, at least 80 wt. %, at least 90 wt. %, at least 95 wt. % or even at least 99 wt. % of propanol. In additional embodiments, the hydrocarbon feed stream may comprise at least 50 wt. %, at least 60 wt. %, at least 70 wt. %, at least 80 wt. %, at least 90 wt. %, at least 95 wt. % or even at least 99 wt. % of butanol. In additional embodiments, the hydrocarbon feed stream or may comprise at least 50 wt. %, at least 60 wt. %, at least 70 wt. %, at least 80 wt. %, at least 90 wt. %, at least 95 wt. % or even at least 99 wt. % of the sum of ethanol, propanol, and butanol.

According to one or more embodiments, the reaction may be a methanol-to-olefin reaction. According to such embodiments, the hydrocarbon feed stream may comprise methanol. According to one or more embodiments, the hydrocarbon feed stream may comprise at least 50 wt. %, at least 60 wt. %, at least 70 wt. %, at least 80 wt. %, at least 90 wt. %, at least 95 wt. % or even at least 99 wt. % of methanol.

In one or more embodiments, the operating of chemical process may include passing the product stream out of the reactor. The product stream may comprise light olefins or alkyl aromatic olefins, such as styrene. As described herein, “light olefins” refers to one or more of ethylene, propylene, or butene. As described herein, butene many include any isomer of butene, such as a-butylene, cis-o-butylene, trans-o-butylene, and isobutylene. In one embodiment, the product stream may comprise at least 50 wt. % light olefins. For example, the product stream may comprise at least 60 wt. % light olefins, at least 70 wt. % light olefins, at least 80 wt. % light olefins, at least 90 wt. % light olefins, at least 95 wt. % light olefins, or even at least 99 wt. % light olefins.

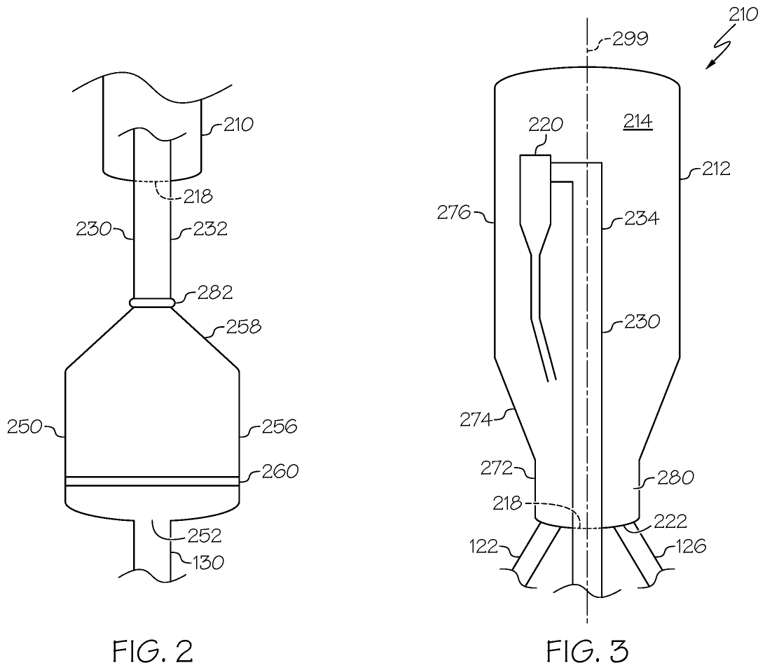

Referring now to FIGS. 1 and 2, the reaction vessel 250 may include a reaction vessel particulate solid inlet port 252 defining the connection of transport riser 130 to the reaction vessel 250. The reaction vessel 250 may additionally include a reaction vessel outlet port 254 in fluid communication with, or directly connected to, the exterior riser segment 232 of the riser 230. As described herein, a “reaction vessel” refers to a drum, barrel, vat, or other container suitable for a given chemical reaction. A reaction vessel may be generally cylindrical in shape (i.e., having a substantially circular cross sectional shape), or may alternately be non-cylindrically shaped, such as prism shaped with cross-sectional shaped of triangles, rectangles, pentagons, hexagons, octagons, ovals, or other polygons or curved closed shapes, or combinations thereof. Reaction vessels, as used throughout this disclosure, may generally include a metallic frame, and may additionally include refractory linings or other materials utilized to protect the metallic frame and/or control process conditions.

Generally, “inlet ports” and “outlet ports” of any system unit of the fluid catalytic reactor system 100 described herein refer to openings, holes, channels, apertures, gaps, or other similar mechanical features in the system unit. For example, inlet ports allow for the entrance of materials to the particular system unit and outlet ports allow for the exit of materials from the particular system unit. Generally, an outlet port or inlet port will define the area of a system unit of the fluid catalytic reactor system 100 to which a pipe, conduit, tube, hose, transport line, or like mechanical feature is attached, or to a portion of the system unit to which another system unit is directly attached. While inlet ports and outlet ports may sometimes be described herein functionally in operation, they may have similar or identical physical characteristics, and their respective functions in an operational system should not be construed as limiting on their physical structures. Other ports, such as the riser port 218, may comprise an opening in the given system unit where other system units are directly attached, such as where the riser 230 extends into the particulate solid separation section 210 at the riser port 218.

The reaction vessel 250 may be connected to a transport riser 130, which in operation, may provide regenerated particulate solids and chemical feed to the reactor section 200. As displayed in FIG. 2, the regenerated particulate solids and the chemical feed may be mixed with a distributor 260 housed in the reaction vessel 250. Referring again to FIG. 1, the particulate solids entering the reaction vessel 250 via transport riser 130 may be passed through standpipe 124 to a transport riser 130, thus arriving from the regeneration section 300. In some embodiments, particulate solids may come directly from the particulate solid separation section 210 via standpipe 122 and into a transport riser 130, where they enter the reaction vessel 250. These particulate solids may be slightly deactivated, but may still, in some embodiments, be suitable for use in the reaction vessel 250.

As depicted in FIGS. 1 and 2, the reaction vessel 250 may be directly connected to the exterior riser segment 232. In one embodiment, the reaction vessel 250 may include a reaction vessel body section 256 and a reaction vessel transition section 258 positioned between the reaction vessel body section 256 and the exterior riser segment 232. The reaction vessel body section 256 may generally comprise a greater diameter than the reaction vessel transition section 258, and the reaction vessel transition section 258 may be tapered from the size of the diameter of the reaction vessel body section 256 to the size of the diameter of the riser 230, such that the reaction vessel transition section 258 projects inwardly from the reaction vessel body section 256 to the exterior riser segment 232. It should be understood that, as used herein, the diameter of a portion of a system unit refers to its general width, as shown in the horizontal direction in FIG. 1.

Additionally, the reaction vessel body section 256 may generally comprise a height, where the height of the reaction vessel body section 256 is measured from the particulate solid inlet port 152 to the reaction vessel transition section 258. In one or more embodiments, the diameter of the reaction vessel body section 256 may be greater than the height of the reaction vessel body section 256. In one or more embodiments, the ratio of the diameter to the height of the reaction vessel body section 256 may be from 5:1 to 1:5. For example, the ratio of the diameter to the height of the particulate solid treatment vessel body section 356 may be from 5:1 to 1:5, from 4:1 to 1:5, from 3:1 to 1:5, from 2:1 to 1:5, from 1:1 to 1:5, from 1:2 to 1:5, from 1:3 to 1:5, from 1:4 to 1:5, from 5:1 to 1:4, from 5:1 to 1:3, from 5:1 to 1:2, from 5:1 to 1:1, from 5:1 to 2:1, form 5:1 to 3:1, from 5:1 to 4:1, or any combination or sub-combination of these ranges.

In one or more embodiments, the reaction vessel 250 may have a maximum cross sectional area that is at least 3 times the maximum cross sectional area of the riser 230. For example, the reaction vessel 250 may have a maximum cross sectional area that is at least 3, at least 4, at least 5, at least 6, at least 7, at least 8, at least 9, or even at least 10 times the maximum cross sectional area of the riser 230. As described herein, unless otherwise explicitly stated, the “cross sectional area” refers to the area of the cross section of a portion of a system component in a plane substantially orthogonal to the direction of general flow of reactants and/or products.

In one or more embodiments, based on the shape, size, and other processing conditions such as temperature and pressure in the reaction vessel 250 and the riser 230, the reaction vessel 250 may operate in a manner that is or approaches isothermal, such as in a fast fluidized, turbulent, or bubbling bed reactor, while the riser 230 may operate in more of a plug flow manner, such as in a dilute phase riser reactor. For example, the reaction vessel 250 may operate as a fast fluidized, turbulent, or bubbling bed reactor and the riser 230 may operate as a dilute phase riser reactor, with the result that the average catalyst and gas flow moves concurrently upward. As the term is used herein, “average flow” refers to the net flow, i.e., the total upward flow minus the retrograde or reverse flow, as is typical of the behavior of fluidized particles in general. As described herein, a “fast fluidized” reactor may refer to a reactor utilizing a fluidization regime wherein the superficial velocity of the gas phase is greater than the choking velocity and may be semi-dense in operation. As described herein, a “turbulent” reactor may refer to a fluidization regime where the superficial velocity of less than the choking velocity and is more dense than the fast fluidized regime. As described herein, a “bubbling bed” reactor may refer to a fluidization regime wherein well-defined bubbles in a highly dense bed are present in two distinct phases. The “choking velocity” refers to the minimum velocity required to maintain solids in the dilute-phase mode in a vertical conveying line. As described herein, a “dilute phase riser” may refer to a riser reactor operating at transport velocity, where the gas and catalyst have about the same velocity in a dilute phase.

In one or more embodiments, the pressure in the reaction vessel 250 may range from 6.0 to 100 pounds per square inch absolute (psia, from about 41.4 kilopascals, kPa, to about 689.4 kPa), but in some embodiments, a narrower selected range, such as from 15.0 psia to 35.0 psia, (from about 103.4 kPa to about 241.3 kPa), may be employed. For example, the pressure may be from 15.0 psia to 30.0 psia (from about 103.4 kPa to about 206.8 kPa), from 17.0 psia to 28.0 psia (from about 117.2 kPa to about 193.1 kPa), or from 19.0 psia to 25.0 psia (from about 131.0 kPa to about 172.4 kPa). Unit conversions from standard (non-SI) to metric (SI) expressions herein include “about” to indicate rounding that may be present in the metric (SI) expressions as a result of conversions.

In additional embodiments, the weight hourly space velocity (WHSV) for the disclosed process may range from 0.1 pound (lb) to 100 lb of chemical feed per hour (h) per lb of catalyst in the reactor (lb feed/h/lb catalyst). For example, where a reactor comprises a reaction vessel 250 that operates as a fast fluidized, turbulent, or bubbling bed reactor and a riser 230 that operates as a riser reactor, the superficial gas velocity may range therein from 2 feet per second (ft/s, about 0.61 meters per second, m/s) to 80 ft/s (about 24.38 m/s), such as from 2 ft/s (about 0.61 m/s) to 10 ft/s (about 3.05 m/s), in the reaction vessel 250, and from 30 ft/s (about 9.14 m/s) to 70 ft/s (about 21.31 m/s) in the riser 230. In additional embodiments, a reactor configuration that is fully of a riser type may operate at a single high superficial gas velocity, for example, in some embodiments at least 30 ft/s (about 9.15 m/s) throughout.

In additional embodiments, the ratio of catalyst to feed stream in the reaction vessel 250 and riser 230 may range from 5 to 100 on a weight to weight (w/w) basis. In some embodiments, the ratio may range from 10 to 40, such as from 12 to 36, or from 12 to 24.

In additional embodiments, the catalyst flux may be from 1 pound per square foot-second (lb/ft²-s) (about 4.89 kg/m²-s) to 30 lb/ft²-s (to about 146.5 kg/m2-s) in the reaction vessel 250, and from 10 lb/ft²-s (about 48.9 kg/m2-s) to 250 lb/ft²-s (about 1221 kg/m2-s) in the riser 230.

Still referring to FIG. 1, the reactor section 200 may comprise a riser 230, which acts to transport reactants, products, and/or particulate solids from the reaction vessel 250 to the particulate solid separation section 210. In one or more embodiments, the riser 230 may be generally cylindrical in shape (i.e., having a substantially circular cross-sectional shape), or may alternately be non-cylindrically shaped, such as prism shaped with cross-sectional shape of triangles, rectangles, pentagons, hexagons, octagons, ovals, or other polygons or curved closed shapes, or combinations thereof. The riser 230, as used throughout this disclosure, may generally include a metallic frame, and may additionally include refractory linings or other materials utilized to protect the metallic frame and/or control process conditions.

According to some embodiments, the riser 230 may include an exterior riser segment 232 and an interior riser segment 234. As used herein, an “exterior riser segment” refers to the portion of the riser that is outside of the particulate solid separation section, and an “interior riser segment” refers to the portion of the riser that is within the particulate solid separation section. For example, in the embodiment depicted in FIG. 1, the interior riser segment 234 of the reactor section 200 may be positioned within the particulate solid separation section 210, while the exterior riser segment 232 is positioned outside of the particulate solid separation section 210.

Referring to FIGS. 1 and 3, the particulate solid separation section 210 may comprise an outer shell 212 where the outer shell 212 may define an interior region 214 of the particulate solid separation section 210. The outer shell 212 may comprise a gas outlet port 216, a riser port 218, and a particulate solid outlet port 222. Furthermore, the outer shell 212 may house a gas/solids separation device 220 and a particulate solid collection area 280 in the interior region 214 of the particulate solid separation section 210.

In one or more embodiments, the outer shell 212 of the particulate solid separation section 210 may define an upper segment 276, a middle segment 278, and a lower segment 272 of the particulate solid separation section 210. Generally, the upper segment 276 may have a substantially constant cross sectional area, such that the cross sectional area does not vary by more than 20% in the upper segment 276. In one or more embodiments, the cross sectional area of the upper segment 276 may be at least three times the maximum cross sectional area of the riser 230. For example, the cross sectional area of the upper segment 276 may be at least 3 times, at least 4 times, at least 5 times, at least 6 times, at least 7 times, at least 8 times, at least 9 times, at least 10 times, at least 12 times, at least 15 times, or even at least 20 times the maximum cross sectional area of the riser 230. In further embodiments, the maximum cross sectional area of the upper segment 276 may be from 5 to 40 times the maximum cross sectional area of the riser 230. For example, the maximum cross sectional area of the upper segment 276 may be from 5 to 40, from 10 to 40, from 15 to 40, from 20 to 40, from 25 to 40, from 30 to 40, from 35 to 40, from 5 to 35, from 5 to 30, from 5 to 25, from 5 to 20, from 5 to 15, or even from 5 to 10 times the maximum cross sectional area of the riser 230.

Additionally, in one or more embodiments, the lower segment 272 of the particulate solid separation section 210 may have a substantially constant cross sectional area, such that the cross sectional area does not vary by more than 20% in the lower segment 272. The cross sectional area of the lower segment 272 may be larger than the maximum cross sectional area of the riser 230 and smaller than the maximum cross sectional area of the upper segment 276. The middle segment 278 may be shaped as a frustum where the cross sectional area of the middle segment 278 is not constant and the cross sectional area of the middle segment 278 transitions from the cross sectional area of the upper segment 276 to the cross sectional area of the lower segment 272 throughout the middle segment 278.

Referring again to FIG. 3, the particulate solid separation section 210 may comprise a central vertical axis 299. The central vertical axis may extend through the top of the particulate solid separation section 210 and the bottom of the particulate solid separation section 210, such that the central vertical axis 299 passes through the upper segment 276, the middle segment 278, and the lower segment 272 of the particulate solid separation section 210. In one or more embodiments, the upper segment 276, the middle segment 278, and the lower segment 272 of the particulate solid separation section 210 may be centered on the central vertical axis 299. For example, in embodiments where the upper segment 276 and the lower segment 272 are substantially cylindrical, the central vertical axis 299 may pass through the midpoint of a diameter of the upper segment 276 and a midpoint of a diameter of the lower segment 272.

As depicted in FIGS. 1 and 3, the interior riser segment 234 of the riser 230 may extend through the riser port 218 of the particulate solid separation section 210. The riser port 218 may be any opening in the outer shell 212 of the particulate solid separation section 210 through which at least the interior riser segment 234 of the riser 230 protrudes into the interior region 214 of the particulate solid separation section 210. In one or more embodiments, the riser port 218 is located on the central vertical axis 299. In one or more embodiments, the riser port 218 is not located on the central vertical axis 299 of the particulate solid separation section 210. In such embodiments, the riser port 218 may be located on a sidewall of the outer shell 212 such that the riser port 218 is neither located on the central vertical axis 299 nor oriented so that the riser 230 extends into the particulate solid separation section 210 in a direction substantially parallel to the central vertical axis 299.

In one or more embodiments, the interior riser segment 234 enters the particulate solid separation section 210 in the lower segment 274. In such embodiments, the interior riser segment 234 passes through at least a portion of the lower segment 274, through at least a portion of the middle segment 278, and at least a portion of the upper segment 276. In one or more embodiments, the interior riser segment 234 enters the particulate solid separation section 210 in the middle segment 278 of the particulate solid separation section 210. In such embodiments, the interior riser segment 234 passes through at least a portion of the middle segment 278 and through at least a portion of the upper segment 276. In such embodiments, the interior riser segment 234 does not pass through the lower segment 272 of the particulate solid separation section 210. In further embodiments, the interior riser segment 234 may enter the particulate solid separation section 210 in the upper segment 276 and the interior riser segment 234 may pass through at least a portion of the upper segment 276. In such embodiments, the interior riser segment 234 does not pass through the lower segment 272 or the middle segment 278.

Referring again to FIG. 3, in the upper segment 276 of the particulate solid separation section 210, the interior riser segment 234 may be in fluid communication with the gas/solids separation device 220. For example, the vertical portion 296 of the interior riser segment 234 may be directly connected to the gas/solids separation device 220. The gas/solids separation device 220 may be any mechanical or chemical separation device that may be operable to separate particulate solids from gas or liquid phases, such as a cyclone or a plurality of cyclones.

According to one or more embodiments, the gas/solids separation device 220 may be a cyclonic separation system, which may include two or more stages of cyclonic separation. In embodiments where the gas/solids separation device 220 comprises more than one cyclonic separation stages, the first separation device into which the fluidized stream enters is referred to a primary cyclonic separation device. The fluidized effluent from the primary cyclonic separation device may enter into a secondary cyclonic separation device for further separation. Primary cyclonic separation devices may include, for example, primary cyclones, and systems commercially available under the names VSS (commercially available from UOP), LD2 (commercially available from Stone and Webster), and RS2 (commercially available from Stone and Webster). Primary cyclones are described, for example, in U.S. Pat. Nos. 4,579,716; 5,190,650; and 5,275,641, which are each incorporated by reference in their entirety herein. In some separation systems utilizing primary cyclones as the primary cyclonic separation device, one or more set of additional cyclones, e.g. secondary cyclones and tertiary cyclones, are employed for further separation of the particulate solids from the product gas. It should be understood that any primary cyclonic separation device may be used in embodiments disclosed herein.

The particulate solids may move upward through the riser 230 from the reaction vessel 250 and into the gas/solids separation device 220. The gas/solids separation device 220 may be operable to deposit separated particulate solids into the bottom of the upper segment 276 or into the middle segment 278 or lower segment 272 of the particulate solid separation section 210. The separated vapors may be removed from the fluid catalytic reactor system 100 via a pipe 120 at a gas outlet port 216 of the particulate solid separation section 210. The separated vapors may comprise light olefins, and as such, may be product stream 410.

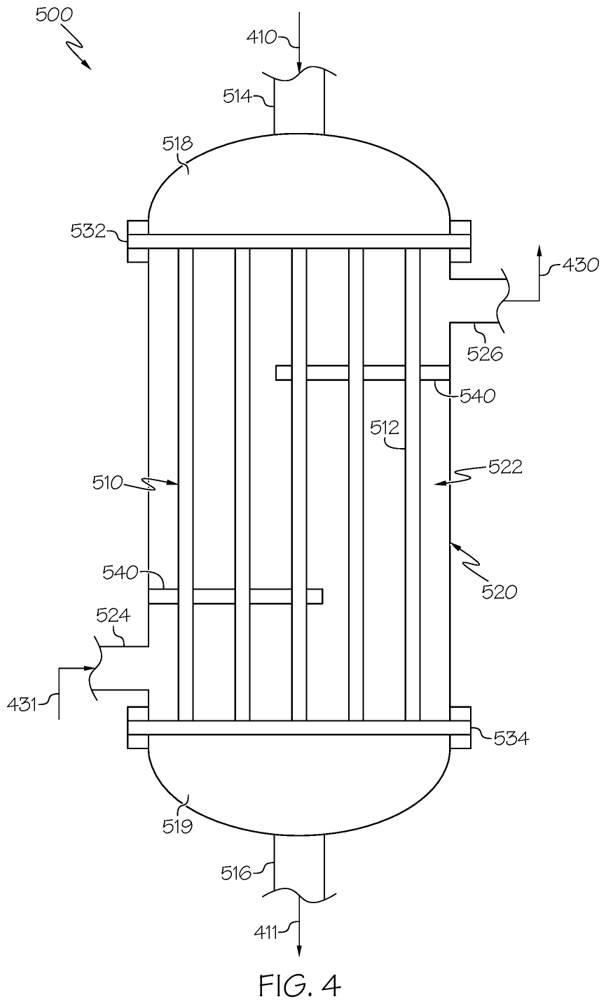

In one or more embodiments, at least a portion of the product stream 410 and at least a portion of the hydrocarbon feed stream 430 may be passed through a feed stream preheater 400 disposed downstream of the reaction vessel 250 of the reactor portion 200. The feed stream preheater 400 may be a shell and tube heat exchanger 500, as depicted in FIG. 4. The shell and tube heat exchanger 500 may be operable to heat at least a portion of the hydrocarbon feed stream 430 through heat transfer from the product stream 410 to the hydrocarbon feed stream 430. Thus, the shell and tube heat exchanger 500 may reduce the temperature of the product stream 411 exiting the feed stream preheater compared to the product stream 410 upstream of the shell and tube heat exchanger 500. Additionally, the shell and tube heat exchanger 500 may increase the temperature of the hydrocarbon feed stream 430 exiting the shell and tube heat exchanger 500 compared to the hydrocarbon feed stream 431 upstream of the shell and tube heat exchanger 500.

As described herein, a “shell and tube heat exchanger” refers to a piece of equipment for transferring heat from a relatively hot fluid to a relatively cold fluid. Referring to FIG. 4, the shell and tube heat exchanger 500 may comprise a plurality of tubes 510 positioned within a shell 520. One fluid flows through the tubes 510, contacting the interior surface of the tubes, and another fluid may flow through the shell, contacting the exterior surface of the tubes. The volume of the heat exchanger defined by the interior surfaces of the tubes is referred to herein as the “tube side” 512, and the volume of the heat exchanger between the exterior surface of the tubes and the interior surface of the shell is referred to herein as the “shell side” 522 of the shell and tube heat exchanger 500. As such, heat may be transferred between the two fluids through the walls of the tubes 510 without the fluids contacting each other. In one or more embodiments, the hydrocarbon feed 430 may flow through the shell side 522 of the shell and tube heat exchanger 500 and the product stream 410 may flow through the tube side 512 of the shell and tube heat exchanger 500.

In one or more embodiments, the shell 520 may be generally cylindrical in shape (i.e., having a substantially circular cross sectional area), or may alternately be non-cylindrically shaped, such as prism shaped with cross-sectional shaped of triangles, rectangles, pentagons, hexagons, octagons, ovals, or other polygons or curved closed shapes, or combinations thereof. Likewise, in one or more embodiments, each tube 510 may be generally cylindrical in shape, or may alternately be non-cylindrically shaped.

The shell and tube heat exchanger 500 may comprise a shell side inlet 524, a shell side outlet 526, a tube side inlet 514, and a tube side outlet 516. The shell side inlet 524 may allow a fluid to enter the shell 520 of the shell and tube heat exchanger 500, and the shell side outlet 526 may allow a fluid to exit the shell 520 of the shell and tube heat exchanger 500. In one or more embodiments, the shell and tube heat exchanger 500 may comprise a second shell side inlet. In one or more embodiments, the heat exchanger may comprise a second shell side outlet. Without intending to be bound by theory, as the shell and tube heat exchanger 500 gets larger, the shell side outlet 526 may increase in size. If the shell side outlet 526 is too large, then the spacing of the baffles 540 may need to be adjusted. Furthermore, using a single shell side outlet 526 and a single shell side inlet 524 may result in uneven flow of fluid through the shell and tube heat exchanger 500. Accordingly, the use of a second shell side outlet 526 and/or a second shell side inlet 524 may result in more uniform distribution of fluid through the shell side 522 of the shell and tube heat exchanger 500 without the need to adjust the spacing of the baffles 540. The benefits of using multiple nozzles may include: better distribution of gas within the heat exchanger, smaller nozzles which enable the nozzles to fit between baffles, and smaller nozzles that help keep the velocity moving along the top tube sheet, which minimizes the chance of coking. Additionally, the shell side nozzle inlets and outlets may be oriented in a hillside or radial manner.

In one or more embodiments, the tube side inlet 514 may allow a fluid to enter a tube side inlet plenum 518. The tube side inlet plenum 518 may be located between the tube side inlet 514 and the inlets of each of the tubes in the plurality of tubes. An inlet tube sheet 532 may separate the tube side inlet plenum 518 from the shell side 522 of the shell and tube heat exchanger 500. The fluid may pass from the tube side inlet 514, through the tube side inlet plenum 518, and then into the tubes 510 comprising the plurality of tubes 510. In one or more embodiments, the tube side outlet 516 may allow a fluid to exit a tube side outlet plenum 519 of the shell and tube heat exchanger 500. The tube side outlet plenum 519 may be positioned between the outlets of each of the tubes 510 in the plurality of tubes 510 and the tube side outlet 516, and an outlet tube sheet 534 may separate the tube side outlet plenum 519 from the shell side 522 of the shell and tube heat exchanger 500.

In one or more embodiments, each of the inlet tube sheet 532 and the outlet tube sheet 534 may support at least a portion of the plurality of tubes 501 and may provide a barrier between the tube side inlet plenum 518 and/or the tube side outlet plenum 519 and the shell side 522 of the shell and tube heat exchanger 500. In one or more embodiments, the inlet tube sheet 532 may be connected to the shell 520 and connected to each tube 510. In one or more embodiments, the outlet tube sheet 534 may be a floating tube sheet. The outlet tube sheet 534 may be connected to each tube 510 and may be connected to the shell 520 by a flexible joint that allows the outlet tube sheet 534 to move within the shell 520. In one or more embodiments, the tube side inlet 514 and the tube side outlet 516 may be on opposite sides of the shell 520. In such embodiments, the heat exchanger 500 may comprise a tube sheet on each end of the shell 520, one near the tube side inlet 514, and one near the tube side outlet 516.

In one or more embodiments, the inlet tube sheet 532, the outlet tube sheet 534, or both may be flexible. Without wishing to be bound by theory, a flexible tube sheet may reduce stress on the tubes 510 and on the shell 520 from differences in the thermal expansion of the tubes 510 and the shell 520. For example, a flexible tube sheet design may include curvature at the junction between the shell and the tube sheet. Increasing the radius this curvature may increase the flexibility of the junction between the shell and the tube sheet, alleviating stress that could be present in that junction. Furthermore, flexibility of the tube sheet may be improved, at least in part, by using materials at the junction between the shell and the tube sheet that have a similar modulus of elasticity at high temperatures. In some conventional tube sheet designs that exhibit less flexibility, the materials used at the junction between the shell and the tube sheet allow for higher stress at elevated temperatures; however, these materials also have a higher differential in modulus of elasticity at those high temperatures. This results in unnecessary stiffness in the tube sheet at the junction between the tube sheet and the shell.

In one or more embodiments, the shell 520 may include one or more baffles 540. The baffles 540 may direct the fluid on the shell side 522 of the shell and tube heat exchanger 500. The baffles 540 may increase the turbulence of the shell side fluid and may direct the flow of the shell side fluid through the shell 520 of the shell and tube heat exchanger 500. Additionally, the baffles 540 may provide support for the plurality of tubes 510 extending axially through the shell 520 of the shell and tube heat exchanger 500. In one or more embodiments, the shell and tube heat exchanger 500 may comprise petal baffles, tube-in-window baffles, no-tube-in-window baffles, disc and doughnut baffles, double segmental baffles, triple segmental baffles, or any other suitable baffles.

In one or more embodiments, the flow of fluid through the shell side 522 of the shell and tube heat exchanger 500 may be substantially axial. As described herein, “axial flow” refers to flow that is substantially parallel to a central axis of the shell of the heat exchanger 500 and substantially parallel to each of the tubes 510 comprising the plurality of tubes 510 extending axially through the shell 520. In such embodiments, the heat exchanger may comprise baffles 540 that promote axial flow of fluid on the shell side 522 of the shell and tube heat exchanger 500. For example, the heat exchanger may comprise expanded metal baffles or rod baffles. Expanded metal baffles may be formed by cutting slits in a sheet of metal and stretching the sheet of metal to form interstices through which the tubes 510 may extend. The interstices may be large enough to allow fluid to flow through the interstices in a direction substantially parallel to the tubes 510. Rod baffles may be formed by multiple rods extending through the plurality of tubes 510 to support the tubes 510. In one or more embodiments, the heat exchanger may comprise baffles 540 formed from grating, such as subway grating. The grating may be formed by water cutting. Like an expanded metal baffle, the grating may comprise interstices through which the tubes 510 may extend. Without intending to be bound by theory, it is believed that when the flow of fluid through the shell side 522 of the shell and tube heat exchanger 500 is substantially axial, there is not as much wasted space due to a no tube in window (NTIW) configuration for the same number of tubes at the same spacing, allowing for a smaller shell 520 to be used.

In one or more embodiments, the shell and tube heat exchanger 500 may comprise a shell expansion joint. The shell expansion joint may be any suitable expansion joint positioned in the shell 520 of the shell and tube heat exchanger 500. For example, the shell and tube heat exchanger may comprise a flute and flange shell expansion joint. Without being bound by theory, it is believed that the shell expansion joint may reduce thermal stress on the shell and tube heat exchanger 500 by allowing the shell of the heat exchanger 500 to expand and contract in an axial direction as a response to elongation or contracting of the tubes 510 that occurs due to thermal gradients between the tubes 510 and the shell 520 and differences in the coefficient of thermal expansion between the tubes 510 and the shell 520.

The shell and tube heat exchanger 500 may also comprise stress reduction features on a joint between the shell 520 and the tube sheet 530. In one or more embodiments, the tube sheet 530 may comprise a notch or a groove. The notch may be a portion of the tube sheet 530 that has been carved out tangential to at least one of the tubes 510. Without being bound by theory, it is believed that the notch may reduce the thermal stress placed on the tube sheet 530 due to the different rates of thermal expansion of the tubes 510 and the shell 520 of the shell and tube heat exchanger 500. Specifically, tube sheets attached to the shell are generally prone to high stress at the corner joint between the tube sheet and the shell. By adding a notch having a compound radius to the corner joint, in which there is a tangential component to the radius, high thermal stress may be dissipated in a more efficient manner than could be achieved in systems without such a notch. In some embodiments, the notch may comprise a radius, a tangential machined cut, and a shallow section. This may allow for the removal of unnecessary material that could add stiffness to the joint between the tube sheet 530 and the shell 520.

In one or more embodiments, the inlet tube sheet 532, the outlet tube sheet 534, or both may be connected to the shell 520 by an expansion joint. In one or more embodiments, the outlet tube sheet 534 is connected to the shell 520 by an expansion joint and may be located inside the vessel shell. The expansion joint may be any suitable expansion joint. In one or more embodiments, the expansion joint may be a corrugated bellows expansion joint or an S shaped flexible joint or an omega or toroidal shaped flexible joint. In one or more embodiments, the expansion joint may comprise stainless steel, such as, but not limited to 321 or 316 stainless steel. Without intending to be bound by theory, it is believed that an expansion joint positioned between the tube sheet and the shell 520 may reduce thermal stress caused by different rates of thermal expansion between the shell 520 and the tube sheet. When the shell and tube heat exchanger 500 is in use, the tubes 510 may be at a different temperature than the shell 520. Accordingly, the amount of thermal expansion for the tubes 510 may be different from the amount of thermal expansion for the shell 520. Using an expansion joint between the tube sheet and the shell 520 may reduce the stress on the shell and tube heat exchanger 500 caused by this difference in thermal expansion.

In one or more embodiments, the shell and tube heat exchanger 500 may be supported by one or more hanging support lugs. The hanging support lugs may be fixed to an outer surface of the shell and tube heat exchanger 500 by any suitable means and may be used to support the shell and tube heat exchanger 500. In one or more embodiments, the hanging support lugs may be flexible to accommodate thermal expansion and contraction of the shell and tube heat exchanger 500. Without intending to be bound by theory, conventional pressure vessels such as reactors and heat exchangers are usually supported by lugs that support the pressure vessels by compression. Hanging support lugs allow for the pressure vessel to freely move in a radial direction. When using handing support lugs, thermal stresses on high temperature systems may be greatly reduced, as such supports allow for radial thermal expansion. In some cases, the hanging support lugs may be flexible by incorporating natural contours and shapes into the lugs. For example, the hanging support lugs may be designed by removing material from portions of the process equipment that are not necessary or that are adding unnecessary stiffness.

In one or more embodiments, the shell 520 of the shell and tube heat exchanger 500 may be formed from 304H SS, Alloy 800, Alloy 800 H, Alloy 800 HT, or other suitable high temperature stainless steels such as 347 SS or 321 SS. In one or more embodiments, the tubes 510 may be formed from 304H SS, Alloy 800, Alloy 800 H, Alloy 800 HT, or other suitable high temperature stainless steels such as 347 SS or 321 SS. In one or more embodiments, each of the inlet tube sheet 532 and the outlet tube sheet 534 may be formed from 304H SS, Alloy 800, Alloy 800 H, Alloy 800 HT, or other suitable high temperature stainless steels such as 347 SS or 321 SS.

In one or more embodiments, the inlet tube sheet 532 may be connected to each of the plurality of tubes 510 by inner bore welding. In some embodiments, the outlet tube sheet 534 may be connected to each of the plurality of tubes 510 by inner bore welding. In such embodiments, the tube sheet may comprise hubs, where each tube is welded to a hub on the inlet tube sheet, where the tube does not pass through the tube sheet. This welding may be accomplished by a tool capable of being inserted through the tube sheet to perform the welding. Without intending to be bound by theory, the use of inner bore welding may reduce the number of crevices in the joints between the tube sheet and the tubes which eliminates the potential of coking by hydrocarbons on the shell side which can grow and force the tubes out of the tube sheet. This may make it easier to maintain the tube sheet and bundle of tubes in the shell and tube heat exchanger 500.

In one or more embodiments, the shell and tube heat exchanger 500 may comprise refractory lining. For example, the refractory lining may be positioned around the tube side inlet 514 where hot product stream 410 is introduced to the heat exchanger 500, and the shell side outlet 526 where heated hydrocarbon feed stream 410 exits the heat exchanger 500. In one or more embodiments, the refractory lining may be positioned on the interior surface of the tube side inlet 514. Without intending to be bound by theory, it is believed that when the pipe carrying hot gas to the tube side inlet is lined with refractory, thermal expansion of that pipe may be minimal. In some embodiments, there is a flange positioned between the tube side inlet 514 and the pipe. Having refractory lining extend past the flange to the tube side inlet 514 may reduce thermal stress on the flange and prevent excessive heat loss. In one or more embodiments, an outlet tube sheet 534 may comprise heat shielding. Without intending to be bound by theory, in some embodiments, gas entering the shell side 522 of the shell and tube heat exchanger 500 may be too cold and may create thermal stress on the outlet tube sheet 534. Accordingly, heat shielding may prevent these cold gasses from excessively cooling the outlet tube sheet 534 and causing excessive thermal stress.

In one or more embodiments, the tubes 510 may be shaped to provide additional surface area. Without being bound by theory, it is believed that increasing the surface area of the tubes 510 may increase the rate of heat transfer between the tube side fluid and the shell side fluid. In one or more embodiments, the surface area of the tubes 510 may be enhanced by the presence of fins on the exterior surface of the tube, the interior surface of the tube, or both. For example, one or more fins may positioned longitudinally or helically on the interior surface of the tube, the exterior surface of the tube, or both. In one or more embodiments, the tubes may be low finned tubes, where the low finned tubes comprise transverse fins that are formed by extruding the base tube material. In one or more embodiments, the tubes 510 may be corrugated or comprise corrugations or interior ribbing. In one or more embodiments, the tubes 510 may be grooved. For example, the tubes 510 may comprise one or more longitudinal grooves or one or more helical grooves on the interior surface of the tube, the exterior surface of the tube, or both. In one or more embodiments, the tubes 510 may comprise a texture on the interior surface of the tube, the exterior surface of the tube, or both. For example, the interior surface of the tube, the exterior surface of the tube, or both may be dimpled. In one or more embodiments, the tubes 510 may comprise any combination of the surface area enhancements described herein.

In one or more embodiments, the ratio of the length of the shell to the diameter of the shell is from 2 to 50. For example, the ratio of the length of the shell to the diameter of the shell is from 2 to 50, from 5 to 50, from 10 to 50, from 15 to 50, from 20 to 50, from 25 to 50, from 30 to 50, from 35 to 50, from 40 to 50, from 45 to 50, from 2 to 45, from 2 to 40, from 2 to 35, from 2 to 30, from 2 to 25, from 2 to 20, from 2 to 15, from 2 to 10, from 2 to 5, or any combination or sub-combination of these ranges. In one or more embodiments, the ratio of the length of the shell to the diameter of the shell is from 2 to 8. For example, the ratio of the length of the shell to the diameter of the shell may be from 2 to 8, from 3 to 8, from 4 to 8, from 5 to 8, from 6 to 8, from 7 to 8, from 2 to 7, from 2 to 6, from 2 to 5, from 2 to 4, from 2 to 3, or any combination or sub-combination of these ranges. Without intending to be bound by theory, it is believed that such a ratio provides a balance between pressure drop through the heat exchanger and mechanical limitations on the inlet tube sheet. For example, a larger ratio of length to diameter for the shell 520 results in a smaller tube sheets, which in turn may reduce the stress caused by thermal expansion of the tube sheets. Furthermore, a larger ratio of length to diameter for the shell 520 may increase the velocity of the fluid flowing through the shell 520 and may increase the pressure drop through the shell and tube heat exchanger 500.

In one or more embodiments, the shell and tube heat exchanger 500 may comprise combinations of the various features contemplated herein. Various features described herein may have synergistic effects when combined. For example, in one or more embodiments, the shell and tube heat exchanger 500 may comprise both an expansion joint between the outlet tube sheet 534 and the shell 520 and refractory lining around the tube side inlet 514. Without intending to be bound by theory, the use of an expansion joint between the outlet tube sheet 534 and the shell 520 in combination with refractory lining may greatly reduce the thermal stress experienced by various components of the heat exchanger. By reducing the thermal stress on the heat exchanger, less expensive metallurgy may be suitable for various components of the heat exchanger.

Referring again to FIGS. 1 and 3 regarding the reactor system 100, the lower segment 272 of the particulate solid separation section 210 may comprise a particulate solid collection area 280. In one or more embodiments, the particulate solid collection area 280 may allow for accumulation of particulate solids within the particulate solid separation section 210. The particulate solid collection area 280 may comprise a stripping section. The stripping section may be utilized to remove product vapors from the particulate solids prior to sending them to the regeneration section 300. As product vapors transported to the regeneration section 300 will be combusted, it is desirable to remove those product vapors with the stripper, which utilizes less expensive gases than product gases.

The particulate solid collection area 280 in the lower segment 272 may comprise a particulate solid outlet port 222. According to one or more embodiments, the bottom of the particulate solid collection area 280 may be curved such that the particulate solid outlet port 222 is located at the lowest portion of the particulate solid collection area 280. Standpipe 126 may be connected to the particulate solid separation section 210 at particulate solid outlet port 222, and the particulate solids may be transferred out of the reactor section 200 via standpipe 126 and into the regeneration section 300. Optionally, the particulate solids may also be transferred directly back into the reaction vessel 250 via standpipe 122. In such embodiments, standpipe 122 and standpipe 126 may each be offset from the central vertical axis 229. Alternatively, the particulate solids may be premixed with regenerated particulate solids in the transport riser 130.

As described herein, portions of system units such as reaction vessel walls, separation section walls, or riser walls, may comprise a metallic material, such as carbon or stainless steel. In addition, the walls of various system units may have portions that are attached with other portions of the same system unit or to another system unit. Sometimes, the points of attachment or connection are referred to herein as “attachment points” and may incorporate any known bonding medium such as, without limitation, a weld, an adhesive, a solder, etc. It should be understood that components of the system may be “directly connected” at an attachment point, such as a weld.

To mitigate damage caused by hot particulate solids and gasses, refractory materials may be used as internal linings of various system components. Refractory materials may be included on the riser 230 as well as the particulate solid separation section 210. It should be understood that while embodiments are provided of specific refractory material arrangements and materials, they should not be considered limiting regarding the physical structure of the disclosed system. For example, refractory liner may extend in the riser 230 along an interior surface of the riser 230 and along interior surfaces of the middle segment 278 and upper segment 276 of the particulate solid separation section 210. The refractory liner may include hex mesh or other suitable refractory materials.

Mechanical loads applied onto the reaction vessel 250, and more specifically the connected vessel nozzles like 218, from the weight of the particulate solids and other parts of the reactor section 200 may be high, and springs may be utilized to allow vessel movement due to thermal differences in the vessel and piping walls. These springs may apply pressure upwardly on the reaction vessel 250 and nozzle 218 when the vessel is empty. When the vessel has an upset catalyst weight, the loads on nozzle 218 could shift downward. This design philosophy decreases the total load in either direction nozzle 218 would see. For example, the reaction vessel 250 may be hung from springs, or springs may be positioned below the reaction vessel 250 to support its weight, the catalyst weight, and to allow for thermal movements. For example, FIG. 1 depicts spring supports 188 mechanically attached to the reactor section 200 at the reaction vessel 250, wherein the reactor section 200 is suspended from a support structure by the spring supports 188.

Additionally, the reaction vessel 250 and riser 230 may undergo thermal expansion. As such, hanging the reaction vessel 250 from spring supports 188 or supporting the reaction vessel 250 with spring supports 188 may relieve tension between the reaction vessel 250 and the exterior riser segment 232. In place of springs, referring now to FIG. 2, an expansion joint 282 may be positioned between the reaction vessel 250 and the exterior riser segment 232. As described herein, an “expansion joint” may refer to a bellows made of metal or other suitable material, such as refractory, plastic, fiber, or an elastomer, which reduces the stress between the system components joined by the expansion joint. For example, expansion joints may be used to reduce stress between system components due to thermal expansion and contraction. In one or more embodiments, an expansion joint 282 may be used in combination with spring supports to mitigate stress caused by thermal expansion between the reaction vessel 250 and the exterior riser segment 232.

After separation in the particulate solid separation section 210, the spent particulate solids are transferred to the regeneration section 300. The regeneration section 300, as described herein, may share many structural similarities with the reactor section 200. As such, the reference numbers assigned to the portions of the regeneration section 300 are analogous to those used with reference to the reactor section 200, where if the final two digits of the reference number are the same the given portions of the reactor section 200 and regeneration section 300 may serve similar functions and have similar physical structure. Thus, many of the present disclosures related to the reactor section 200 may be equally applied to the regeneration section 300, and distinctions between the reactor section 200 and the regeneration section 300 will be highlighted hereinbelow.

Referring now to the regeneration section 300, as depicted in FIG. 1, the particulate solid treatment vessel 350 of the regeneration section 300 may include one or more reactor vessel inlet ports 352 and a reactor vessel outlet port 354 in fluid communication with, or even directly connected to the exterior riser segment 332 of the riser 330. The particulate solid treatment vessel 350 may be in fluid communication with the particulate solid separation section 210 via standpipe 126, which may supply spent particulate solids from the reactor section 200 to the regeneration section 300 for regeneration. The particulate solid treatment vessel 350 may include an additional reactor vessel inlet port 352 where gas inlet 128 connects to the particulate solid treatment vessel 350. The gas inlet 128 may supply reactive gases, such as supplemental fuel gasses and oxygen containing gasses, including air, which may be used to at least partially regenerate the particulate solids. In one or more embodiments, the particulate solid treatment vessel 350 may comprise multiple additional reactor vessel inlet ports, and each additional reactor vessel inlet port may supply a different reactive fluid to the particulate solid treatment vessel 350. For example, the particulate solids may be coked following the reactions in the reaction vessel 250, and the coke may be removed from the particulate solids by a combustion reaction. For example, oxygen containing gasses, such as air, may be fed into the particulate solid treatment vessel 350 via the gas inlet 128 to oxidize the particulate solids, or supplemental fuel may be fed into the particulate solid treatment vessel 350 and combusted to heat the particulate solids.

In one or more embodiments, regenerating the particulate solids may occur in the presence of an oxygen containing gas and regenerating the particulate solids may comprise one or more of oxidizing the particulate solids by contact with an oxygen containing gas, combusting coke present on the particulate solid or combusting a supplemental fuel to heat the particulate solid.

As depicted in FIG. 1, the particulate solid treatment vessel 350 may be directly connected to the exterior riser segment 332 of the riser 330. In one embodiment, the particulate solid treatment vessel 350 may include a particulate solid treatment vessel body section 356 and a particulate solid treatment vessel transition section 358. The particulate solid treatment vessel body section 356 may generally comprise a greater diameter than the particulate solid treatment vessel transition section 358, and the particulate solid treatment vessel transition section 358 may be tapered from the size of the diameter of the particulate solid treatment vessel body section 356 to the size of the diameter of the exterior riser segment 332 such that the particulate solid treatment vessel transition section 358 projects inwardly from the particulate solid treatment vessel body section 356 to the exterior riser segment 332.

It should be understood that the particulate solid treatment vessel 350 and the riser 330 may undergo thermal expansion and, as described hereinabove, may be supported by spring supports 188. Additionally, the particulate solid treatment vessel 350 may be joined to the riser 330 by an expansion joint in one or more embodiments. For example, an expansion joint may be positioned between the particulate solid treatment vessel 350 and the exterior riser segment 332.

Still referring to FIG. 1, the particulate solid separation section 310 includes an outer shell 312 defining an interior region 314 of the particulate solid separation section 310. The outer shell 312 may comprise a gas outlet port 316, a riser port 318, and a particulate solid outlet port 322. Furthermore, the outer shell 312 may house a gas/solids separation device 320 and a solid particulate collection area 380 in the interior region 314 of the particulate solid separation section 310.

Similar to the reactor section 200, the outer shell 312 of the particulate solid separation section 310 may define an upper segment 376, a middle segment 374, and a lower segment 372 of the particulate solid separation section 310, as described hereinabove regarding particulate solid separation section 210.

Referring again to FIG. 1, the riser 330 extends into the interior region 314 of the regeneration section 300 via a riser port 318. In one or more embodiments, the interior riser segment 334 extends through at least a portion of the lower segment 372 of the particulate solid separation section 310. In one or more embodiments, the interior riser segment 334 does not pass through the lower segment 372 of the particulate solid separation section 310.

Referring to FIG. 1, the outer shell 312 may further house a riser termination device 378. The riser termination device may be positioned proximate to the interior riser segment 334. The flue gasses and particulate solids passing through the riser 330 may be at least partially separated by riser termination device 378. The flue gasses and remaining particulate solids may be transported to a secondary separation device 320 in the particulate solid separation section 310. The secondary separation device 320 may be any device suitable to separate solid particles from gasses, such as a cyclone or a series of cyclones, as described hereinabove regarding gas/solids separation device 220. The secondary separation device 320 may deposit separated particulate solids into the bottom of the upper segment 376, the middle segment 374 or the lower segment 372 of the particulate solid separation section 310. As such, the particulate solids may flow by gravity from the bottom of the upper segment 376 or the middle segment 374 to the lower segment 372.

In one or more embodiments, the flue gasses may be removed from the fluid catalytic reactor system 100 via a pipe 128 at gas outlet port 316 of the particulate solid separation section 310. The flue gasses passed through outlet port 316 may form flue gas stream 610. In one or more embodiments, at least a portion of the flue gas stream 610 and at least a portion of the oxygen containing gas stream 630 may be passed through a gas preheater 600 disposed downstream of the regenerator vessel 350 of the regenerator portion 300. The gas preheater 600 may be a shell and tube heat exchanger 500, as described in detail hereinabove and depicted in FIG. 4. The shell and tube heat exchanger 500 may be operable to heat at least a portion of the oxygen containing gas stream 630 through heat transfer from the flue gas stream 610 to the oxygen containing gas stream 630. Thus, the shell and tube heat exchanger 500 may reduce the temperature of the flue gas stream 611 exiting the feed stream preheater compared to the flue gas stream 610 upstream of the shell and tube heat exchanger 500. Additionally, the shell and tube heat exchanger 500 may increase the temperature of the oxygen containing gas stream 630 exiting the shell and tube heat exchanger compared to the oxygen containing gas stream 631 upstream of the shell and tube heat exchanger.

In one or more embodiments, the oxygen containing gas stream 630 may flow through the shell side 522 of the shell and tube heat exchanger 500 and the flue gas stream 610 may flow through the tube side 512 of the shell and tube heat exchanger 500. It should be understood that the gas preheater 600 comprises a shell and tube heat exchanger 500, as previously described in relation to the feed stream preheater 400 on the reactor side 200 of the fluid catalytic reactor system 100, and that any disclosure regarding the shell and tube heat exchanger 500 described in the context of the feed stream preheater 400 may likewise be applicable to the gas preheater 600.

Referring again to FIG. 1, the lower segment 372 of the particulate solid separation section 310 may comprise a solid particulate collection area 380, which may allow for the accumulation of particulate solids in the lower segment 372. In one or more embodiments, the solid particulate collection area 380 may comprise one or more of an oxygen soak zone, an oxygen stripping zone, and a reduction zone. The solid particulate collection area 380 may further comprise a particulate solid outlet port 322 similar to particulate solid outlet port 222 described hereinabove.

In one or more embodiments, standpipe 124 may be in fluid communication with particulate solid outlet port 322, and regenerated particulate solids may be passed from the regeneration section 300 to the reactor section 200 through standpipe 124. As such, the particulate solids may be continuously recirculated through the reactor system 100.

The subject matter of the present disclosure has been described in detail and by reference to specific embodiments. It should be understood that any detailed description of a component or feature of an embodiment does not necessarily imply that the component or feature is essential to the particular embodiment or to any other embodiment. Further, it should be apparent to those skilled in the art that various modifications and variations can be made to the described embodiments without departing from the spirit and scope of the claimed subject matter.

For the purposes of describing and defining the present disclosure it is noted that the terms “about” or “approximately” are utilized in this disclosure to represent the inherent degree of uncertainty that may be attributed to any quantitative comparison, value, measurement, or other representation. The terms “about” and/or “approximately” are also utilized in this disclosure to represent the degree by which a quantitative representation may vary from a stated reference without resulting in a change in the basic function of the subject matter at issue.

It is noted that one or more of the following claims utilize the term “wherein” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.”

It should be understood that where a first component is described as “comprising” a second component, it is contemplated that, in some embodiments, the first component “consists” or “consists essentially of” that second component. It should further be understood that where a first component is described as “comprising” a second component, it is contemplated that, in some embodiments, the first component comprises at least 10%, at least 20%, at least 30%, at least 40%, at least 50%, at least 60%, at least 70%, at least 80%, at least 90%, at least 95%, or even at least 99% that second component (where % can be weight % or molar %).

Additionally, the term “consisting essentially of” is used in this disclosure to refer to quantitative values that do not materially affect the basic and novel characteristic(s) of the disclosure. For example, a chemical composition “consisting essentially” of a particular chemical constituent or group of chemical constituents should be understood to mean that the composition includes at least about 99.5% of a that particular chemical constituent or group of chemical constituents.

It should be understood that any two quantitative values assigned to a property may constitute a range of that property, and all combinations of ranges formed from all stated quantitative values of a given property are contemplated in this disclosure. It should be appreciated that compositional ranges of a chemical constituent in a composition should be appreciated as containing, in some embodiments, a mixture of isomers of that constituent. In additional embodiments, the chemical compounds may be present in alternative forms such as derivatives, salts, hydroxides, etc.

1. A method for producing olefins, the method comprising:
contacting a hydrocarbon feed stream with a particulate solid in a reaction vessel, the contacting of the hydrocarbon feed stream with the particulate solid reacting the hydrocarbon feed stream to form a product stream;
separating the particulate solid from the product stream in a gas/solids separation device; and
passing at least a portion of the product stream and a portion of the hydrocarbon feed stream through a feed stream preheater, wherein:
the feed stream preheater comprises a shell and tube heat exchanger comprising a shell, a plurality of tubes extending axially through the shell, a shell side inlet, a shell side outlet, a tube side inlet, a tube side outlet, an inlet tube sheet, and an outlet tube sheet; and
the outlet tube sheet is connected to the shell by an expansion joint.

2. The method of claim 1, wherein the at least a portion of the product stream enters the shell and tube heat exchanger through the tube side inlet and exits the shell and tube heat exchanger through the tube side outlet.

3. The method of claim 1, wherein the at least a portion of the hydrocarbon feed stream enters the shell and tube heat exchanger through the shell side inlet and exits the shell and tube heat exchanger through the shell side outlet.

4. The method of claim 1, wherein the inlet tube sheet, the outlet tube sheet, or both comprise a notch tangential to at least one of the tubes.

5. The method of claim 1, wherein the shell and tube heat exchanger comprises one or more hanging support lugs that support the shell and tube heat exchanger.

6. The method of claim 1, wherein the shell and tube heat exchanger comprises a second shell side outlet.

7. The method of claim 1, wherein the tubes comprise one or more of: helical fins, longitudinal fins, helical grooves, longitudinal grooves, corrugations, and dimples.

8. The method of claim 1, wherein flow of the hydrocarbon feed stream through the shell of the shell and tube heat exchanger is substantially axial.

9. The method of claim 1, wherein the shell and tube heat exchanger further comprises one or more baffles selected from expanded metal baffles, rod baffles, grating, petal baffles, tube-in-window baffles, no-tube-in-window baffles, disc and doughnut baffles, double segmental baffles, and triple segmental baffles.

10. The method of claim 1, wherein inlet tube sheet is connected to each of the plurality of tubes by inner bore welding.

11. The method of claim 1, wherein the shell and tube heat exchanger comprises a refractory lining around the tube side inlet.

12. The method of claim 1, wherein the ratio of a length of the shell to a diameter of the shell is from 2 to 8.

13. A method for regenerating a particulate solid, the method comprising:
regenerating the particulate solid in a particulate solid treatment vessel in the presence of an oxygen containing gas, where the regenerating of the particulate solid comprises one or more of:
oxidizing the particulate solid by contact with an oxygen containing gas;
combusting coke present on the particulate solid; or
combusting a supplemental fuel to heat the particulate solid;
separating the particulate solid from flue gasses in a gas/solids separation device; and
passing at least a portion of the flue gasses and at least a portion of the oxygen containing gas through a gas preheater, wherein:
the gas preheater comprises a shell and tube heat exchanger comprising a shell, a plurality of tubes extending axially through the shell, a shell side inlet, a shell side outlet, a tube side inlet, a tube side outlet, an inlet tube sheet and an outlet tube sheet; and
the outlet tube sheet is connected to the shell by an expansion joint.

14. The method of claim 13, wherein the at least a portion of the flue gasses enters the shell and tube heat exchanger through the tube side inlet and exits the shell and tube heat exchanger through the tube side outlet.

15. The method of claim 13, wherein the at least a portion of the oxygen containing gas enters the shell and tube heat exchanger through the shell side inlet and exits the shell and tube heat exchanger through the shell side outlet.
